(19) United States
(12) Patent Application Publication
(10) Pub. No.: US 2015/0044524 A1
(43) Pub. Date: Feb. 12, 2015

(54) Solar Power Generation Method and Generation Apparatus

(71) Applicant: TAANE Co., Miyagi (JP)

(72) Inventor: Taneaki Oikawa, Miyagi (JP)

(21) Appl. No.: 14/390,379

(22) PCT Filed: Mar. 28, 2013
(86) PCT No.: PCT/JP2013/059301

§ 371 Date: Oct. 2, 2014

(30) Foreign Application Priority Data
Apr. 2, 2012 (JP) PCT/JP2012/058863

(51) Int. Cl. H01M 14/00

(52) U.S. Cl. CPC H01M 14/005
USPC 429/52; 429/111

(57) ABSTRACT

A solar power generation method involves generating power by irradiating ionized hydrogen water, in which ortho hydrogen molecules or hydrogenated hydrogen with ion binding properties has been dissolved, with light that includes at least waves with a wavelength of 193 nm, and then generating a potential difference between the ionized hydrogen water and water containing cations.

This patent application is a national phase filing under section 371 of PCT/JP2013/059301, filed Apr. 2, 2012, which claims the priority of International patent application PCT/JP2012/058863, filed Apr. 2, 2012, each of which is incorporated herein by reference in its entirety.

### TECHNICAL FIELD

The present invention relates to a method and apparatus for generating electric power using solar rays, and in specific embodiments, to a method for generating electric power using a hydrogen plasma field in ionized hydrogen water at ordinary temperature and atmospheric pressure.

### BACKGROUND

Power generation using solar rays, as a renewable and reusable energy, has been attracting attention. As a material that can be used for solar power generation, single crystal silicon, polycrystalline silicon, and amorphous silicon are known. However, there has been an issue in that their energy conversion efficiency is not so high. For example, Japanese patent document JP-A-2000-106451 discloses an apparatus of solar power generation, in which solar power generation members are disposed based on a predetermined rules to improve conversion efficiency. In addition, infrared light can be collected as heat energy (Japanese patent document JP-A-2011-198825).

### SUMMARY OF THE INVENTION

Embodiments of the present invention provide a novel method and apparatus for solar power generation.

Other embodiments of the present invention provide a method and apparatus for solar power generation using a hydrogen plasma generated in ionized hydrogen water at ordinary temperature and atmospheric pressure.

A method for generating electric power according to embodiments of the present invention generates electric power by radiating light that contains at least a wavelength of 193 nm to ionized hydrogen water that contains ortho-hydrogen molecules or ionically bonded hydrogen being dissolved therein. A potential difference is generated between the ionized hydrogen water and water that contains positive ions. Preferably, the light may be solar rays. Alternatively, the light may be vacuum ultraviolet rays. Preferably, a negative electrode is immersed in the ionized hydrogen water and a positive electrode is immersed in the water that contains positive ions, thereby a potential difference is generated between the electrodes. For example, sea water can be used for the water that contains positive ions.

An apparatus for generating electric power according to the present invention comprises a first container for containing ionized hydrogen water that contains ortho-hydrogen molecules or ionically bonded hydrogen dissolved therein. A second container contains water that contains positive ions. A first electrode is provided in the first container, and a second electrode is provided in the second container. A radiation source radiates light that contains at least a wavelength of 193 nm to the ionized hydrogen water. Preferably, the first container contains a material that allows at least a wavelength of 193 nm to pass through, and the radiation source radiates light through the material. Preferably, the apparatus for generating electric power further comprises a charge storing element electrically coupled to the first and second electrodes.

According to the present invention, power generation can be done by a novel method that does not exist in prior art.

### BRIEF DESCRIPTION OF THE DRAWINGS

FIG. 1 is a table illustrating a classification of hydrogen molecules;

FIG. 2, which includes FIGS. 2A and 2B, illustrates in (2A) a structure of an ortho-hydrogen molecule, and in (2B) a structure of a para-hydrogen molecule;

FIG. 3 is a schematic view of a water-soluble hydrogen molecule and a water-insoluble hydrogen molecule;

FIG. 4A is a graph illustrating the relation over time between oxidation reduction potential (ORP) and pH, where hydrogen gas of para-hydrogen molecules is added to water;

FIG. 4B is a graph illustrating the relation over time between dissolved hydrogen and pH in the water of FIG. 4A;

FIG. 5A is a graph illustrating the relation over time between oxidation reduction potential (ORP) and pH, where hydrogen gas of ortho-hydrogen molecules is added to water;

FIG. 5B illustrates the relation over time between dissolved hydrogen and pH in the water of FIG. 5A;

FIG. 6A is a graph illustrating the relation over time between dissolved hydrogen and pH, where oxygen gas is added to the water of FIG. 5A;

FIG. 6B is a graph illustrating the relation over time between dissolved hydrogen and pH, where an oxide is added to the water of FIG. 5A;

FIG. 7 is a flowchart illustrating steps in a method for generating a hydrogen plasma field according to an embodiment of the present invention;

FIG. 8 is a photo showing a state of emulsion oil that is emulsified by ionized hydrogen water;

FIG. 9 is a photo showing a state of emulsion oil of FIG. 8 to which solar energy is irradiated; and

FIG. 10, which includes FIGS. 10A and 10B, illustrates in (10A) a configuration example of an apparatus for generating a hydrogen plasma field according to an embodiment of the present invention, and in (10B) a configuration example of an apparatus for emulsification according to an embodiment of the present invention;

FIG. 11 is a flowchart illustrating steps in a method for generating a hydrogen plasma field according to a second embodiment of the present invention; and

FIG. 12 illustrates a principle of solar power generation that uses ionized hydrogen water according to an embodiment of the present invention.

### DETAILED DESCRIPTION OF ILLUSTRATIVE EMBODIMENTS

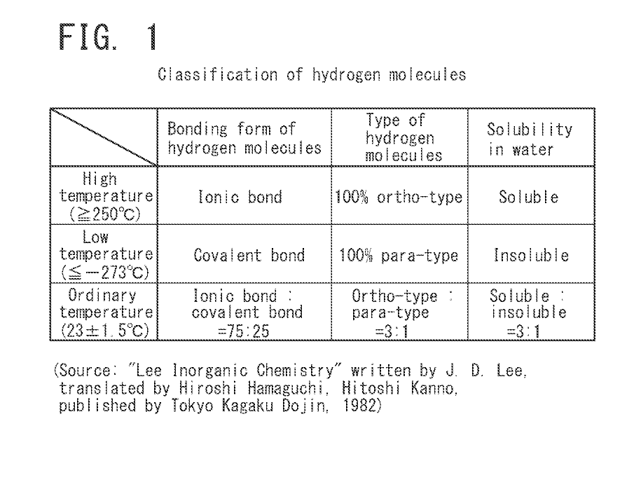

In FIG. 1, hydrogen molecules are classified with reference to temperature. As shown in FIG. 1, the bonding form of hydrogen molecules is ionic bond at high temperatures (equal to or greater than 250 degrees Celsius), and covalent bond at low temperatures (equal to or less than −273 degrees Celsius). At ordinary temperature (23±1.5 degrees Celsius), the ratio of ionic bond to covalent bond is 75%:25%.

The type of hydrogen molecules is 100% ortho-type in a case where their hydrogen bond is ionic bond. On the other hand, the type of hydrogen molecules is 100% para-type in a case where their hydrogen bond is covalently bond. At ordinary temperature, the ratio of ortho-type to para-type is 3:1.

Ionically bonded hydrogen is water-soluble. On the other hand, covalently bonded hydrogen is water-insoluble. At ordinary temperature, the ratio of soluble to insoluble is 3:1. These relations between hydrogen molecules and temperatures are derived by referring to “Lee Inorganic Chemistry” written by J. D. Lee, translated into Japanese by Hiroshi Hamaguchi, Hitoshi Kanno, published by Tokyo Kagaku Dojin, 1982.

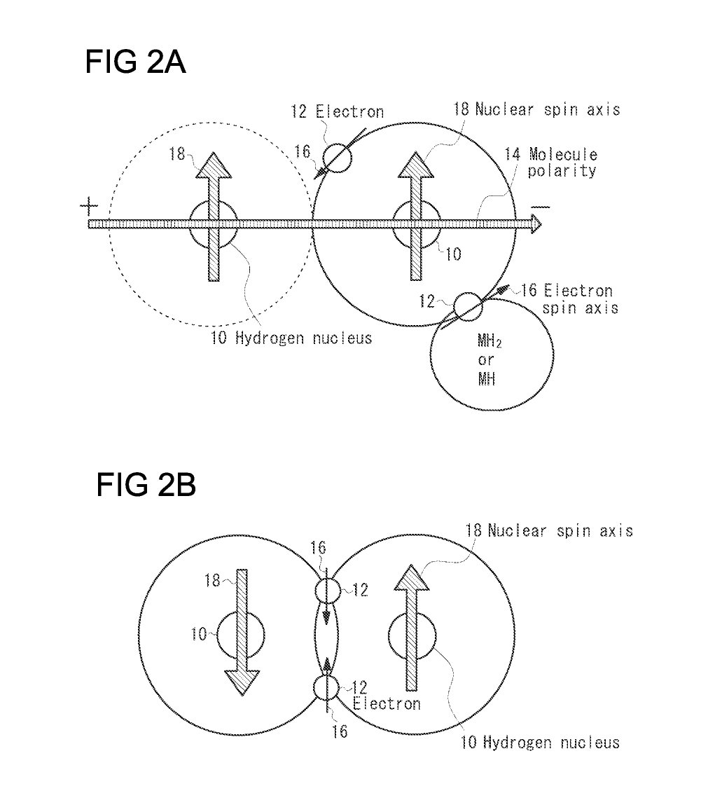

FIG. 2 (A) illustrates a structure of a water-soluble, ortho-hydrogen molecule. FIG. 2 (B) illustrates a structure of a water-insoluble, para-hydrogen molecule. In the ortho-hydrogen molecule form, as illustrated in FIG. 2 (A), nuclear spin axes 18 of two hydrogen nuclei 10 are in the same orientation, and two electrons 12 freely move around one hydrogen nucleus 10. As a result, a molecule polarity 14 as illustrated in FIG. 2 (A) occurs. On the other hand, in the para-hydrogen molecule form, the orientations of the nuclear spin axes 18 are opposite and two electrons 12 are shared by two hydrogen nuclei 10, as illustrated in FIG. 2 (B). As a result, no molecule polarity occurs. Electronic spin axis is indicated by a reference numeral 16.

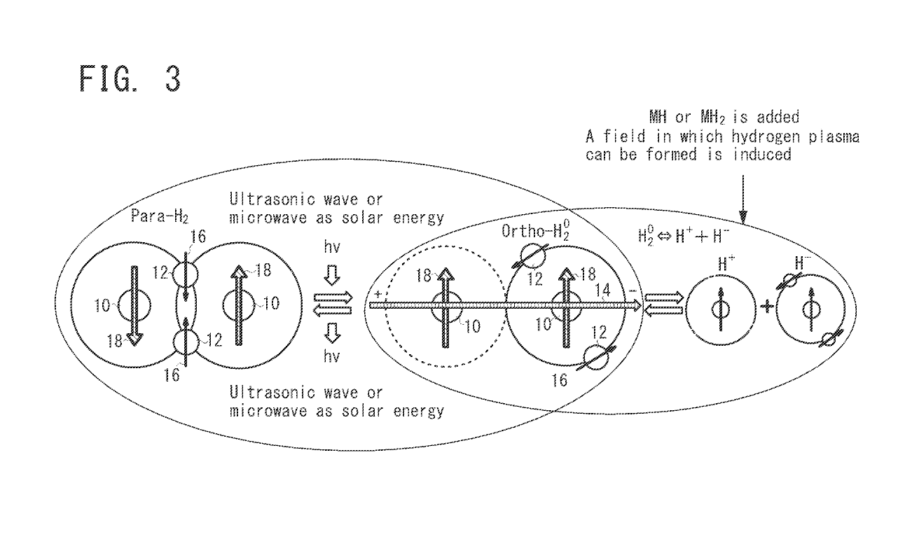

FIG. 3 is a schematic view of water-insoluble para-H₂ and water-soluble ortho-H₂. As described above, at a low temperature of −273 degrees Celsius, 100% of hydrogen molecules are water-insoluble para-type, in other words, in a state of covalently bonded hydrogen. The covalently bonded hydrogen is not ionized even when it is put into water, i.e., H₂=H·H.

On the other hand, in an oxygen-free reduction state at high temperatures equal to or greater than 250 degrees Celsius, 100% of hydrogen molecule are water-soluble ortho-type, in other words, in a state of ionically bonded hydrogen. When solar energy hv is irradiated to para-hydrogen molecules, hydrogen molecules are converted from para-type into ortho-type. When the radiation of the solar energy hv is stopped, hydrogen molecules are converted from ortho-type into para-type. This is experimented in: Michael Frunzi et al., “A Photochemical On-Off Switch for Tuning the Equilibrium Mixture of H₂ Nuclear Spin Isomers as a Function of Temperature”, Journal of the American Chemical Society (JACS), No. 133, pp. 14232-14235, 2011. In addition, as illustrated in FIG. 2 (A) and FIG. 3, an addition of MH or MH₂ (M stands for a metal, and MH or MH₂ stands for a metal hydride) induces a field in which a hydrogen plasma field can be formed, as described later.

Results of an experiment on para- and ortho-hydrogen molecules are now described. For the experiment, MM-60R available from DKK-TOA was used for an ORP/pH meter, and DH-35A available from DKK-TOA was used for a dissolved hydrogen meter.

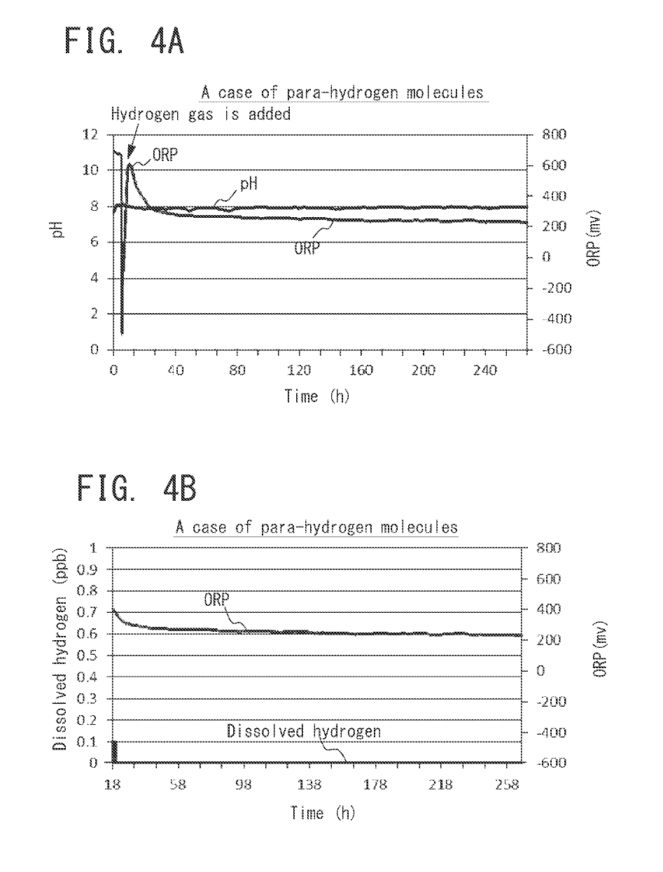

Water used for the experiment was the water to which hydrogen gas of para-hydrogen molecules was added. FIG. 4A illustrates the relation over time between oxidation reduction potential (ORP) and pH, where hydrogen gas of para-hydrogen molecules is added to water. FIG. 4B illustrates the relation over time between dissolved hydrogen and pH in the solution of FIG. 4A. ORP temporally decreases when hydrogen gas is added, however, ORP soon returns to its original potential. In addition, there is almost no change in pH. Hydrogen gas is temporally generated when hydrogen gas is added, however, after that, hydrogen gas is not generated so much. It can be found that hydrogen is not ionized when covalently bonded hydrogen molecules are put into water, and hydrogen is not dissolved in the water.

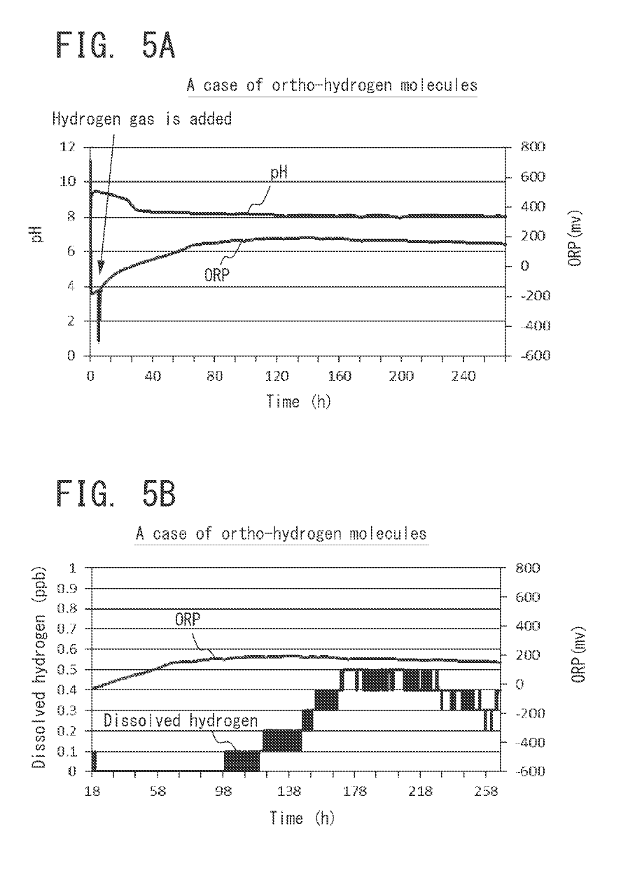

FIG. 5A illustrates the relation over time between oxidation reduction potential (ORP) and pH, where hydrogen gas of ortho-hydrogen molecules is added to water. FIG. 5B illustrates the relation over time between dissolved hydrogen and pH in the water of FIG. 5A. ORP decreases when hydrogen gas is added, and after that, ORP gradually increases. In addition, pH is about pH 9 when hydrogen gas is added, and after that, the value gradually converges on about pH 8. In addition, as illustrated in FIG. 5B, hydrogen is gradually generated after 84 hours have elapsed, and hydrogen is continuously generated even after 250 hours. In other words, it can be found that hydrogen is ionized when ortho-hydrogen molecules are put into water, and hydrogen is dissolved in the water.

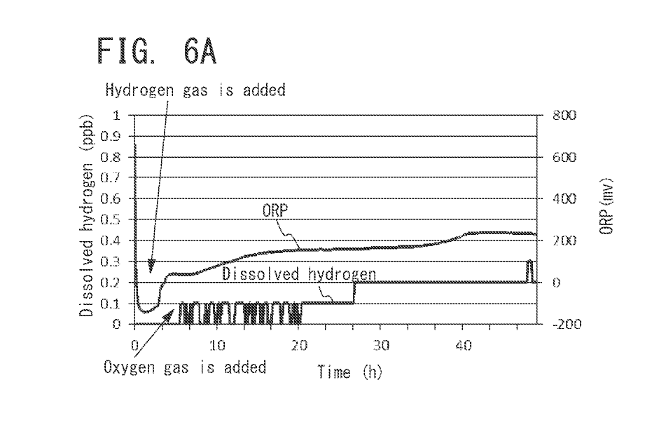

FIG. 6A illustrates the relation over time between ORP and dissolved hydrogen, where ortho-hydrogen molecules are added to water as in FIG. 5A and then oxygen gas is added thereto. It can be found that, after oxygen gas is added, hydrogen that has been dissolved in the water is forced to be generated. After that, the generation of hydrogen continues over 40 hours.

FIG. 6B illustrates that, when ortho-hydrogen molecules are added to water as in FIG. 5A and then an oxide (a substance comprising an acid) is added, hydrogen that has been dissolved in the water is abruptly generated in a large amount, and the amount reaches 80 ppb at its peak. After that, the generation of hydrogen continues over 90 hours. As a result, the amount of dissolved hydrogen molecules in ionized hydrogen would be an accumulated amount of dissolved hydrogen molecules generated in a measuring time period.

As such, when ionically bonded hydrogen molecules (ortho-type) are put into water, hydrogen is ionized and becomes stable as in H₂ [symbol] H⁺+H⁻, and thus ionized hydrogen water (plasma water) is formed. On the other hand, hydrogen is not ionized when covalently bonded hydrogen molecules (para-type) are put into water, i.e., H₂=H·H, resulting in non-ionized hydrogen water. Ionized hydrogen water can be stored at ordinary temperature and atmospheric pressure. In addition, it has been confirmed that the antioxidative ability of the water is kept over two and half years.

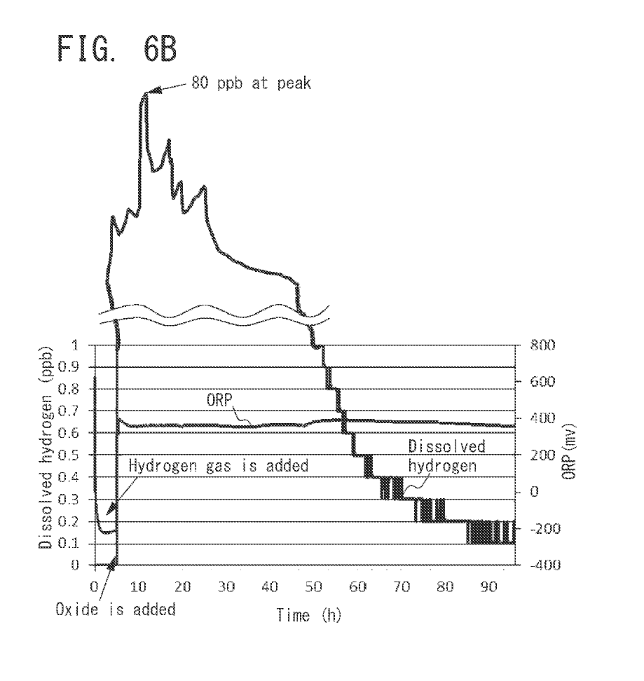

A method for generating a hydrogen plasma field according to an embodiment of the present invention is now described with respect to FIG. 7. First, ionized hydrogen water is prepared as a solution (for example, water) in which ortho-hydrogen molecules are dissolved (S101). Ionized hydrogen water comprises ortho-hydrogen molecules or ionically bonded hydrogen molecules, and hydrogen molecules are ionized as in H₂⁰ [symbol] H⁺+H⁻ in liquid. Such ionized hydrogen water may be obtained, for example, by adding a metal hydride such as CaH₂, MgH₂, etc. to water. For the metal hydride to be added, other than those described above, an alkali metal, an alkali earth metal, a Group 13 or Group 14 metal shown on the periodic table of elements may be used.

Then, ultrasonic waves or microwaves as solar energy are radiated into the ionized hydrogen water (S102). Instead of irradiating using solar rays, artificially generated ultrasonic waves or microwaves of a selected wavelength may be radiated into the ionized hydrogen water. In the ionized hydrogen water, hydrogen molecules are ionized as in H₂⁰ [symbol] H⁺+H⁻, thereby micro bubbles as atomized particles are formed. When ultrasonic waves or microwaves are radiated into the ionized hydrogen water, micro bubbles are agitated (S103), and micro cavitation occurs (S104), and finer micro bubbles are formed (S105), and a field in which hydrogen plasma can be formed (a field in which hydrogen plasma can be decomposed and synthesized) is induced (S106). The finer micro bubbles reunite together and grow into larger micro bubbles, and the micro bubbles burst when they grow up to a certain size they cannot withstand, and thus hydrogen plasma is generated (S107). The development and burst of the micro bubbles occur sequentially in water. As such, when a field in which hydrogen plasma can be formed is induced in liquid of ionized hydrogen water and then atomized micro bubbles burst, a hydrogen plasma field is generated.

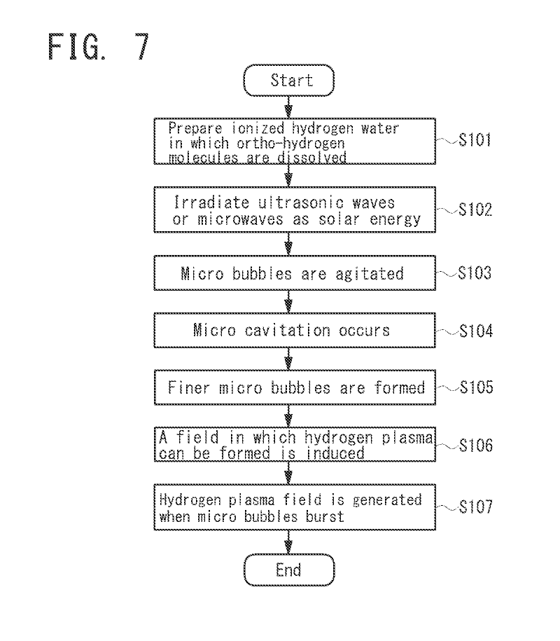

An example is now described in which a method for generating a hydrogen plasma field of the present invention is applied to a method for manufacturing emulsion oil. By generating a hydrogen plasma field in ionized hydrogen water, emulsion oil with high quality can be stably generated. The photo in FIG. 8 shows emulsion oil having various droplet sizes. The emulsion oil is generated in ionized hydrogen water by soaking into ultrapure water 5% of CaH₂ and 5% of CaO and 5% of MgH₂ and 5% of MgO that are generated by reduction-firing CaO and MgO, which are mixed at a weight ratio ratio of 1:1, in an oxygen-free reduction atmosphere. The diameter of some droplets may be 20 micrometers, and the diameter of some other droplets may be 50 micrometers. It should be noted that the oil emulsion described herein has been emulsified by ionized hydrogen water without adding a surfactant or an emulsifier or the like.

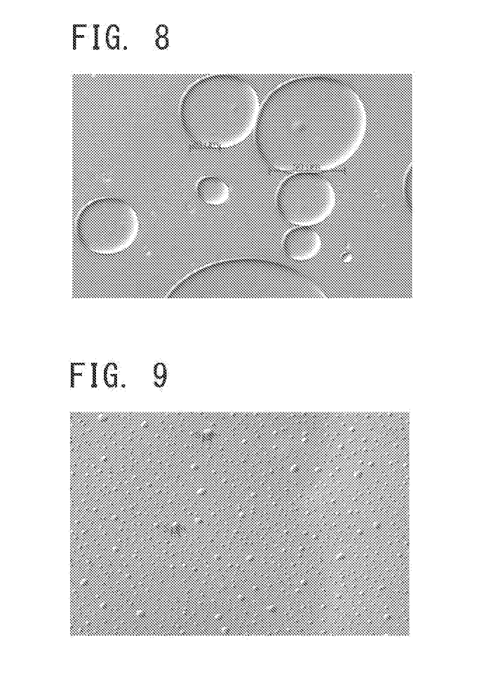

To the emulsion oil shown in FIG. 8, ultrasonic waves or microwaves as solar energy are radiated. As described above, ionized hydrogen water induces a field in which a hydrogen plasma field can be formed, and a hydrogen plasma field is generated when micro bubbles that are agitated by solar energy burst. FIG. 9 shows emulsion oil after solar rays are radiated into the emulsion oil of FIG. 8. As obvious also from this photo, it can be found that droplet sizes become finer by the generation of the hydrogen plasma field. In the example in FIG. 9, the diameter of one droplet is about 5 micrometers.

The droplet size of emulsion oil becomes finer by irradiating solar rays thereto. However, when the radiation of solar energy is stopped, the droplet size of the emulsion oil returns to its original size, in other words, becomes relatively large, as large droplet size as shown in FIG. 8. Therefore, the droplet size of emulsion oil can be altered by controlling the radiation of solar rays, or the radiation of artificially generated micro waves or ultrasonic waves, to the emulsion oil.

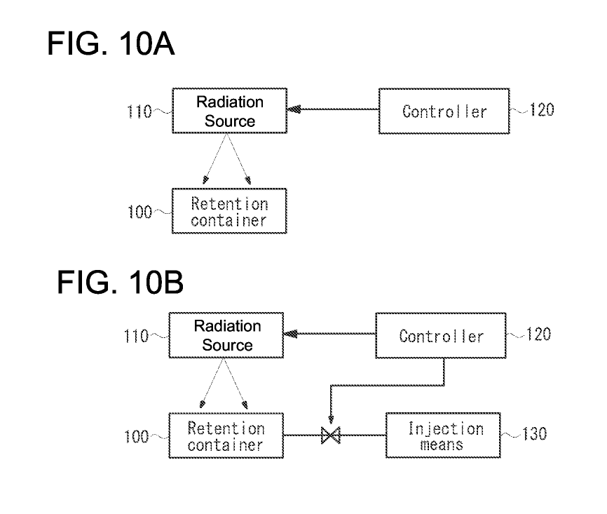

FIG. 10 (A) is a block diagram illustrating a configuration example of an apparatus for generating a hydrogen plasma field according to an embodiment of the present invention. The apparatus for generating a hydrogen plasma field of this embodiment is configured to comprise a retention container 100 for retaining ionized hydrogen water in which at least ortho-hydrogen molecules are dissolved. A radiation source 110 radiates ultrasonic waves or microwaves to the ionized hydrogen water in the retention container 100, and a controller 120 controls the radiation of the radiation source 110. In a case where the radiation source 110 performs radiation of solar energy, the radiation source 110 may be configured to comprise a shutter that passes through or shields solar rays. The controller 120 may control open and close of a shutter, or the time of the shutter to be opened or closed.

FIG. 10 (B) is a block diagram illustrating a configuration example of an apparatus for emulsification according to an embodiment of the present invention. The apparatus for emulsification of this embodiment comprises, in addition to the configuration of FIG. 10 (A), an injection device 130 for injecting oil. In a case where oil solidifies at ordinary temperature, the oil is heated to be liquefied, and the oil is mixed with the ionized hydrogen water in the retention container 100. The controller 120 controls via a valve, for example, the timing and amount of the oil to be injected.

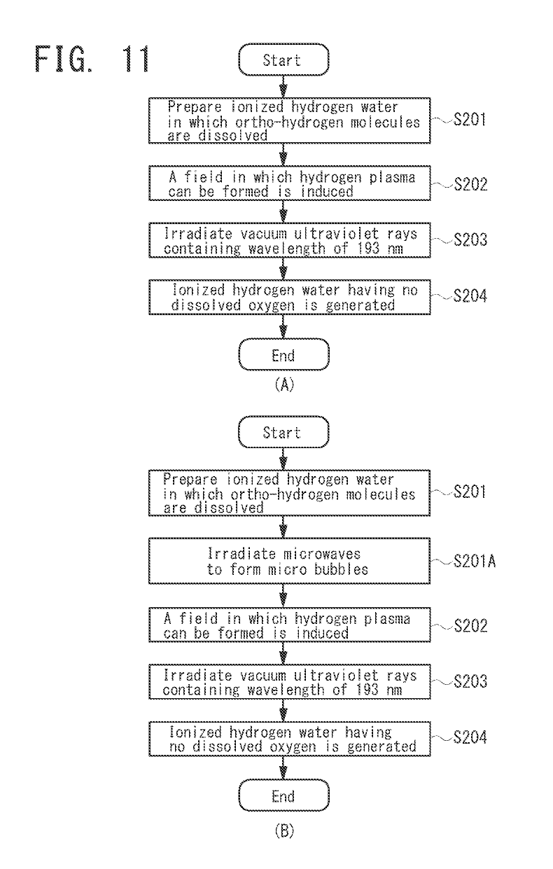

A method for generating a hydrogen plasma field according to a second embodiment of the present invention is now described with reference to a flowchart in FIG. 11. Similarly to the embodiment described above and illustrated in FIG. 7, ionized hydrogen water that contain ionically bonded hydrogen molecules, i.e., ortho-hydrogen molecules, is prepared (S201). Such ionized hydrogen water may be obtained, for example, by creating a metal hydride (MH₂ or MH) based on a manufacturing method, for example, as in Japanese patent number 4,404,657 invented by the inventor, and then by suspending the metal hydride (MH₂ or MH) in water such as tap water. This induces water in which a hydrogen plasma field can be formed (S202).

When vacuum ultraviolet rays (for example, a commercially available ultraviolet (UV) lamp such as an argon excimer lamp UV lamp (a wavelength of 193 nm)) are radiated toward the water in which a hydrogen plasma field can be formed (S203), alkaline reduced mineral ion water, in which no or almost no dissolved oxygen is present, can be obtained (S204). In other words, hydrogen plasma water that contains hydrogen molecule being dissolved as in H₂⁰ [symbol] H⁺+H⁻, i.e., ionized hydrogen water, can be obtained. The optical energy of a wavelength of 193 nm=a frequency of 50 GHz (frequency of hydrogen) contained in solar rays or vacuum ultraviolet lamp causes photolysis of the water in which a hydrogen plasma field has been induced, and thus the water is vaporized into hydrogen gas (4H₂↑) and oxygen gas (O₂↑), resulting in alkaline reduced water with six electrons being left in the water. In the water, there is no or almost no dissolved oxygen. It was confirmed by experiments that no or almost no dissolved oxygen is present when solar rays are radiated to such ionized hydrogen water.

FIG. 11 illustrates in (B) another example of the second embodiment of the present invention. In the flowchart in FIG. 11 (B), similar processes to those used for the first embodiment illustrated in FIG. 7 may be used for inducing a field in which hydrogen plasma can be generated. In other words, microwaves are radiated to a solution that contain ionically bonded hydrogen molecules (ortho-hydrogen molecules) to form micro bubbles (S201A), and a field in which hydrogen plasma can be generated is formed (S202). The microwaves contain at least a wavelength of 193 nm. In subsequent steps, similarly to those in FIG. 11 (A), vacuum ultraviolet rays of a wavelength of 193 nm or a frequency of 50 GHz are radiated (S203) to generate ionized hydrogen water (hydrogen plasma water) having no dissolved oxygen in a vacuum sate (S204).

A method for generating hydrogen according to the second embodiment of the present invention may use an apparatus for generating a hydrogen plasma field illustrated in FIG. 10(A). In this case, for the radiation source 110, an excimer laser UV lamp may be preferably used as a light source that contains vacuum ultraviolet rays of at least a wavelength of 193 nm. In addition, the second embodiment of the present invention can be applied also to an apparatus for emulsification as illustrated in FIG. 10(B).

As described above, according to the present invention, a hydrogen plasma field can be generated in water or in liquid at ordinary temperature and atmospheric pressure and in a vacuum, which is a system completely different from a hydrogen plasma field that has been conventionally generated in an atmosphere at a high temperature and high pressure.

A third embodiment of the present invention is now described. The third embodiment of the present invention relates to solar power generation that uses ionized hydrogen water in which a hydrogen plasma field can be formed as described in the first and second embodiment. As described above, microwaves of 193 nm (50 GHz) have a sufficient energy to disconnect the coupling between two hydrogen atoms and one oxygen atom through electrons. Therefore, when vacuum ultraviolet rays that correspond to that wavelength are radiated toward ionized hydrogen water that contains no dissolved oxygen, photolysis of the water is substantially caused, and thus atomized particles are generated, causing evaporation of the water. At that time, in the ionized hydrogen water, electrons remain in the water since there is no space for the electrons, which have coupled hydrogen molecules together, to go, resulting in electron-rich ionized hydrogen water, i.e., hydrogen plasma-additive water.

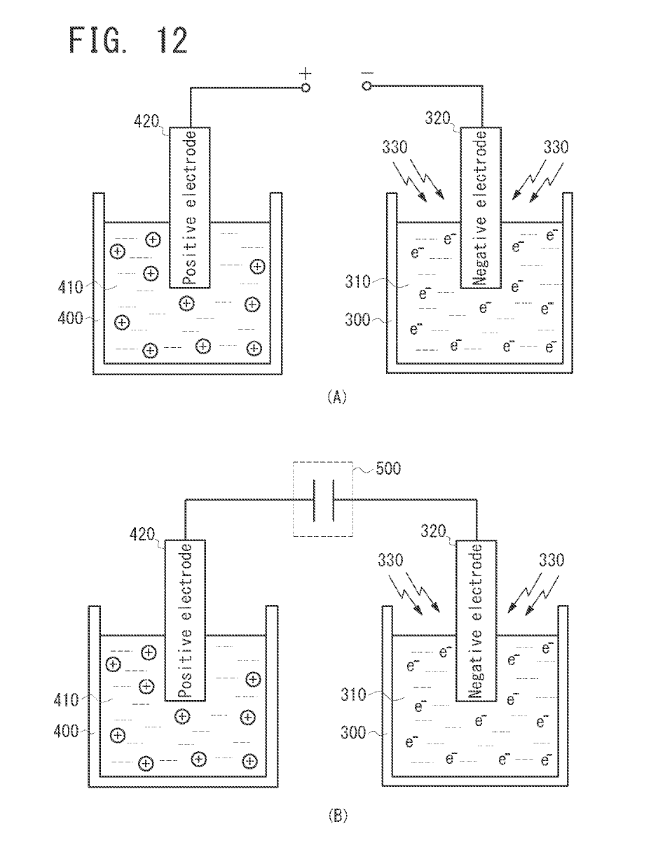

By utilizing this principle, for example, when artificial sea water with abundant positive ions and ionized hydrogen water (hydrogen plasma water) with abundant electrons are contained in containers, respectively, and a copper (Cu) plate, for example, is used for a positive electrode and a magnesium (Mg) plate, for example, is used for a negative electrode, and then solar rays are irradiated thereto, a potential difference is generated between the electrodes and current flows. FIG. 12(A) illustrates a principle of solar power generation using the generation of a hydrogen plasma. In FIG. 12(A), ionized hydrogen water 310 in which a hydrogen plasma field can be formed is contained in a container 300, and a negative electrode 320 is immersed therein. In a preferred embodiment, the container 300 may be made of a transparent material that allows at least a wavelength of 193 nm to pass through. In addition, in a preferred embodiment, the container 300 may be made of a transparent material that allows solar rays to pass through. On the other hand, artificial sea water 410 with abundant positive ions is contained in a container 400, and a positive electrode 420 is immersed therein.

When solar rays 330 that contain a wavelength of 193 nm are radiated toward the ionized hydrogen water 310, the optical energy of a wavelength of 193 nm (a frequency of 50 GHz) causes photolysis of the water in which a hydrogen plasma field has been induced, and thus the water is vaporized into hydrogen gas (4H₂↑) and oxygen gas (O₂↑), resulting in electron-rich ionized hydrogen water with six electrons being left in the water. In that situation, when the positive electrode 420 and the negative electrode 320 are connected with a conductor, current flows. In addition, as shown in FIG. 12(B), by connecting to a charge storing element or a charge storing device 500 such as a capacitor between the electrodes, charge can be accumulated in the charge storing element, and a load can be electrically driven by using the accumulated power.

As described above, by radiating solar rays into ionized hydrogen water in which a hydrogen plasma field can be formed, a hydrogen plasma field is generated to make the ionized hydrogen water electron-rich, which enables power generation that uses solar rays 100%. In the embodiments described above, artificial sea water was used as the water with abundant positive ions, however, other than artificial sea water, any other water that contain positive ions can be used.

Although preferred embodiments of the present invention have been described in detail, the present invention is not to be limited to specific embodiments, and various modifications and alternations can be made without departing from the scope and the spirit of the invention.

1-9. (canceled)

10. A method for generating electric power by radiating light that contains at least a wavelength of 193 nm into ionized hydrogen water that contains ortho-hydrogen molecules or ionically bonded hydrogen that are dissolved therein, wherein a potential difference is generated between the ionized hydrogen water and water that contains positive ions.

11. The method according to claim 10, wherein the light comprises solar rays.

12. The method according to claim 10, wherein the light comprises vacuum ultraviolet rays.

13. The method according to claim 10, wherein a negative electrode is immersed in the ionized hydrogen water and a positive electrode is immersed in the water that contains positive ions, wherein a potential difference is generated between the negative and positive electrodes.

14. The method according to claim 13, wherein the light comprises solar rays.

15. The method according to claim 13, wherein the light comprises vacuum ultraviolet rays.

16. The method according to claim 13, wherein the water that contains positive ions is sea water.

17. The method according to claim 10, wherein the water that contains positive ions is sea water.

18. The method according to claim 10, wherein the light is radiated into the ionized hydrogen water that contains ortho-hydrogen molecules that are dissolved therein.

19. The method according to claim 10, wherein the light is radiated into the ionized hydrogen water that contains ionically bonded hydrogen that is dissolved therein.

20. An apparatus used for generating electric power, comprising:
a first container that contains ionized hydrogen water that contains ortho-hydrogen molecules or ionically bonded hydrogen dissolved therein;
a second container that contains water that contains positive ions;
a first electrode disposed in the first container;
a second electrode disposed in the second container; and
a radiation source located to radiate light that contains at least a wavelength of 193 nm into the ionized hydrogen water.

21. The apparatus according to claim 20, wherein the first container contains a material that allows a wavelength of at least 193 nm to pass through, and the radiation source radiates light through the material.

22. The apparatus according to claim 21, further comprising a charge storing element electrically coupled to the first and second electrodes.

23. The apparatus according to claim 22, wherein radiation source radiates solar rays.

24. The apparatus according to claim 20, wherein radiation source radiates solar rays.

25. The apparatus according to claim 20, further comprising a charge storing element electrically coupled to the first and second electrodes.

26. The apparatus according to claim 20, wherein the first container contains ionized hydrogen water that contains ortho-hydrogen molecules dissolved therein.

27. The apparatus according to claim 20, wherein the first container contains ionized hydrogen water that contains ionically bonded hydrogen dissolved therein.
